(19) United States
(12) Patent Application Publication
(10) Pub. No.: US 2026/0346790 A1
(43) Pub. Date: Nov. 5, 2026

(54) DRIVING ASSISTANCE DEVICE

(71) Applicant: TOYOTA JIDOSHA KABUSHIKI KAISHA, Aichi (JP)

(72) Inventor: Kazuki FUKAZAWA, Toyota-shi (JP)

(21) Appl. No.: 19/653,115

(22) Filed: Apr. 21, 2026

(30) Foreign Application Priority Data
Apr. 23, 2025 (JP) 2025-071193

(51) Int. Cl. B60R 1/27; B60Q 9/00; G01S 15/931

(52) U.S. Cl. CPC B60R 1/27; B60Q 9/008; G01S 15/931; B60R 2300/8093

(57) ABSTRACT

A processor of a driving assistance device is configured to, when a three-dimensional object is detected by an object detection sensor, determine whether a predetermined condition for determining that a risk of contact between the three-dimensional object and an own vehicle is high is satisfied, assign a standard value to a transparency of the object detection image relating to the three-dimensional object when the predetermined condition is satisfied, and assign a value higher than the standard value to a transparency of the object detection image relating to the three-dimensional object when the predetermined condition is not satisfied.

### BACKGROUND

The present invention relates to a driving assistance device including a camera for capturing a surrounding area of an own vehicle to acquire a surrounding image and an object detection sensor for acquiring a position of a three-dimensional object present in the surrounding area, and having a function of superimposing and displaying, on the surrounding image, information relating to the position of the three-dimensional object acquired by the object detection sensor.

### RELATED ART

A driving assistance device has been proposed that includes a camera for capturing a surrounding area of an own vehicle to acquire a surrounding image (G) and an object detection sensor for acquiring a position of a three-dimensional object present in the surrounding area, and has a function of superimposing and displaying, on the surrounding image, information relating to the position of the three-dimensional object acquired by the object detection sensor (see, for example, Patent Document 1 below). This driving assistance device (hereinafter referred to as a “conventional device”) has a function of, when a three-dimensional object is not detected by the object detection sensor, superimposing and displaying, on the surrounding image, an image indicating a detectable range of the object detection sensor.

### PATENT DOCUMENTS

Patent Document 1: Japanese Unexamined Patent Application Publication No. 2008-186132

### SUMMARY

Incidentally, in order to call attention of a driver of an own vehicle to a three-dimensional object located near the own vehicle, there is a case where a driving assistance device is configured such that an image indicating a detection result of an object detection sensor (object detection image) is superimposed and displayed on a predetermined area of a surrounding image (an area corresponding to a position (direction) of the three-dimensional object acquired by the object detection sensor). For example, among the surrounding image, a predetermined section in a direction in which the three-dimensional object is present is filled in “yellow” or “red.” In this case, since a part of the surrounding image is covered and hidden by the object detection image, there is a possibility that the driver may have difficulty visually recognizing an image of the corresponding part of the surrounding image (a photograph acquired by the camera (for example, a photograph of the three-dimensional object itself and a white line drawn on a road surface around the three-dimensional object)).

One of objects of the present invention is to provide a driving assistance device having a function of superimposing and displaying information acquired by an object detection sensor on a surrounding image indicating surroundings of an own vehicle, the driving assistance device having a function of displaying the information in an appropriate manner according to a situation.

In order to achieve the above object, the driving assistance device (1) of the present invention includes:
an in-vehicle sensor (20) including a camera (22) for acquiring a surrounding image (G) which is an image of a surrounding area of an own vehicle and an object detection sensor (21) for acquiring information relating to a position of a three-dimensional object present in a predetermined object-detectable area (D) within the surrounding area;
a display device (30) for displaying an image; and
a processor (10) configured to control the display device such that an object detection image(S) indicating a detection result of the three-dimensional object is superimposed and displayed on, among an entire area (R) of the surrounding image, an area corresponding to a position of the three-dimensional object detected by the object detection sensor.

The processor is configured to, when the three-dimensional object is detected by the object detection sensor, determine whether a predetermined condition for determining that a risk of contact between the three-dimensional object and the own vehicle is high is satisfied, assign a standard value to a transparency of the object detection image relating to the three-dimensional object when the predetermined condition is satisfied, and assign a value higher than the standard value to a transparency of the object detection image relating to the three-dimensional object when the predetermined condition is not satisfied.

When a three-dimensional object is detected by an object detection sensor, a part of a surrounding image is covered by an object detection image as a detection result when the object detection image is superimposed and displayed on the surrounding image, and thus there is a possibility that a driver may have difficulty visually recognizing an image of the corresponding part (a part of the surrounding image). Here, if transparency of the object detection image is uniformly increased in order to solve this problem, there is a possibility that the driver may have difficulty recognizing that the object detection image is being displayed. Therefore, in a driving assistance device according to the present invention, a processor adjusts transparency of each object detection image according to a situation when superimposing and displaying the object detection image on the surrounding image. Specifically, in a first situation in which a risk of contact between the three-dimensional object detected by the object detection sensor and an own vehicle is relatively high, the processor assigns a standard value (a value having relatively low transparency) to transparency of an object detection image relating to the three-dimensional object. On the other hand, in a second situation in which the risk of contact is relatively low, the processor assigns a value higher than the standard value to transparency of an object detection image relating to the three-dimensional object. That is, the processor controls the display device such that an object detection image relating to a three-dimensional object having a high risk of contact with the own vehicle is displayed in a manner more noticeable than an object detection image relating to a three-dimensional object having a low risk of contact. As described above, in the present invention, in the first situation in which a risk of contact between an own vehicle and a three-dimensional object is high, it is allowed that visibility of the surrounding image is slightly reduced and a degree of calling attention to the three-dimensional object is increased. On the other hand, in the second situation in which a risk of contact between an own vehicle and a three-dimensional object is low, it is allowed that a degree of calling attention is slightly reduced and visibility of the surrounding image is increased. As described above, according to the present invention, it is possible to provide a driving assistance device having a function of superimposing and displaying information acquired by an object detection sensor on a surrounding image indicating surroundings of an own vehicle, the driving assistance device having a function of displaying the information in an appropriate manner according to a situation.

In a driving assistance device according to one aspect of the present invention,
the processor is configured to determine that the predetermined condition is satisfied when a distance between the three-dimensional object and an own vehicle or a time predicted to be required until the three-dimensional object and the own vehicle come into contact is equal to or less than a threshold.

According to this, the processor can relatively easily determine whether a condition for determining that a risk of contact between an own vehicle and a three-dimensional object is high is satisfied.

In a driving assistance device according to another aspect of the present invention,
the processor is configured to determine that the predetermined condition is not satisfied when a distance between the three-dimensional object and an own vehicle is equal to or less than a threshold and when it is determined that the distance is constant or increasing.

Even if an own vehicle and a three-dimensional object are in a relatively close state, when the distance does not change or is increasing, a risk of contact tends to be constant or decrease. In the driving assistance device according to this aspect, in this situation, the predetermined condition for determining that the risk of contact is high is not satisfied. Accordingly, visibility of a surrounding image (an image of an area in which the three-dimensional object is located) is improved.

In a driving assistance device according to another aspect of the present invention,
the processor is configured to acquire a recognition level of a driver of an own vehicle and determine that the predetermined condition is not satisfied when it is determined that the recognition level exceeds a threshold.

According to this, when the recognition level of the driver (attention to a three-dimensional object located around an own vehicle) is relatively high, a relatively high value (a value higher than the standard value) is assigned to transparency of an object detection image regardless of a distance between an own vehicle and the three-dimensional object or a time required until the own vehicle and the three-dimensional object come into contact. Accordingly, visibility of the surrounding image is improved.

In a driving assistance device according to another aspect of the present invention,
the processor is configured to activate a buzzer mounted on an own vehicle when a distance between the three-dimensional object and the own vehicle or a time predicted to be required until the three-dimensional object and the own vehicle come into contact transitions from a state exceeding a threshold to a state equal to or less than the threshold, and determine that the recognition level exceeds the threshold when an occupant of the own vehicle is in a state in which activation of the buzzer is temporarily manually disabled.

According to this, the processor can relatively easily determine whether the recognition level of the driver exceeds the threshold.

### BRIEF DESCRIPTION OF THE DRAWINGS

FIG. 1 is a block diagram of a driving assistance device according to one embodiment of the present invention.

FIG. 2 is an example of an image displayed on an image display device when a risk of contact between an own vehicle and a pedestrian located diagonally forward to the right of the own vehicle is high.

FIG. 3 is an example of an image displayed on the image display device when a risk of contact between an own vehicle and a pedestrian located diagonally forward to the right of the own vehicle is low.

FIG. 4A is a front half portion of a flowchart of a program executed by a CPU in order to realize an attention calling function.

FIG. 4B is a rear half portion of a flowchart of a program executed by the CPU in order to realize the attention calling function.

### DESCRIPTION OF THE EMBODIMENTS

### Outline

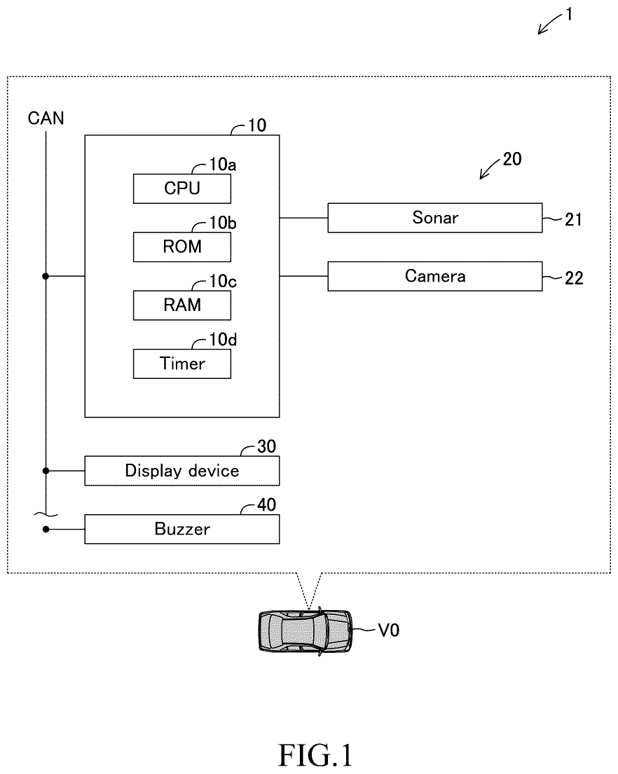

As shown in FIG. 1, a driving assistance device 1 according to one embodiment of the present invention is applied to a vehicle V0 (hereinafter referred to as an “own vehicle”). The own vehicle has an autonomous driving function. The driving assistance device 1 has a function (attention calling function) of, in a situation where the autonomous driving function of the own vehicle is disabled and a driver is performing a manual driving operation, calling attention of the driver to a detected object by superimposing and displaying information acquired by an object detection sensor mounted on the own vehicle on an image acquired by a camera mounted on the own vehicle.

### Specific Configuration

Next, a configuration of the driving assistance device 1 will be specifically described. As shown in FIG. 1, the driving assistance device 1 includes an ECU 10, an in-vehicle sensor 20, an image display device 30, and a buzzer 40.

The ECU 10 includes a microcomputer including a CPU 10a, a ROM 10b, a RAM 10c, a timer 10d, and the like. The ECU 10 is connected to other ECUs via a CAN (communication network).

The in-vehicle sensor 20 includes a sonar 21 as an object detection sensor (positioning sensor) for acquiring information relating to a three-dimensional object OBx (x=a, b, . . . ) located around the own vehicle. The in-vehicle sensor 20 also includes a camera 22 for acquiring an image of a surrounding area of the own vehicle.

The sonar 21 includes a plurality of transmitting/receiving units. The transmitting/receiving units are, for example, incorporated into a front end surface, side surfaces, and a rear end surface of the own vehicle. Each transmitting/receiving unit emits ultrasonic waves toward a surrounding area (front, right, left, and rear) of the own vehicle, and receives ultrasonic waves (reflected waves) reflected by a three-dimensional object (for example, another vehicle parked in a parking spot adjacent to a parking spot in which the own vehicle is to be parked, a pedestrian located near the parking spot in which the own vehicle is to be parked, and the like) present within these emission ranges. The sonar 21 further includes a signal processing unit. Based on a time from when the transmitting/receiving unit emits the ultrasonic waves until the transmitting/receiving unit receives the reflected waves, the signal processing unit provides, to the ECU 10 as three-dimensional object information, information indicating each area in which reflection points of the ultrasonic waves are distributed (an area occupied by each three-dimensional object OBx around the own vehicle (a distance from the own vehicle and a direction as viewed from the own vehicle)).

Here, an object-detectable area of the sonar 21 has a belt-like (oblong) shape surrounding the own vehicle in a plan view.

The camera 22 includes an imaging device. The imaging device incorporates, for example, an imaging element such as a CCD (charge coupled device) or a CIS (CMOS image sensor). The imaging device is installed, for example, at a front end portion, a right end portion, a left end portion, and a rear end surface of the own vehicle. Each imaging device captures a front area, a right area, a left area, and a rear area of the own vehicle at a predetermined frame rate to acquire an image (image data). Each imaging device provides the acquired image to the ECU 10.

The image display device 30 acquires an image display command from the ECU 10 and displays an image in accordance with the command.

The buzzer 40 acquires a sounding command from the ECU 10 and reproduces a relatively short warning sound (a beep sound, a chime, etc.) each time the buzzer 40 acquires the command. As will be described later, when the ECU 10 determines that a risk of contact between the own vehicle and a three-dimensional object is high, the ECU 10 controls the buzzer 40 such that a predetermined warning sound is reproduced (warning sound playback function). Note that a driver can temporarily manually disable the warning sound playback function. For example, from a time point at which the driver sets a predetermined switch (icon) (not shown) to an off state until a predetermined return condition is satisfied, the warning sound playback function is disabled. Note that the driver can disable the warning sound playback function (interrupt reproduction of the warning sound) while the warning sound is being reproduced by the buzzer 40. In addition, the driver can disable the warning sound playback function in advance at a time point before the warning sound is reproduced by the buzzer 40. Note that, for example, the return condition is satisfied at a time point at which a predetermined time has elapsed from a time point at which the warning sound playback function is disabled by a manual operation, or at a time point at which the own vehicle starts again after being parked.

### Attention Calling Function

The ECU 10 successively acquires three-dimensional object information from the sonar 21. The ECU 10 also successively acquires, from each imaging device of the camera 22, images obtained by capturing a front area, a rear area, a left area, and a right area, and synthesizes (transforms) these images to generate (acquire) a plan view (hereinafter referred to as a “surrounding image G”) which is an image obtained by looking down on a surrounding area of the own vehicle from directly above.

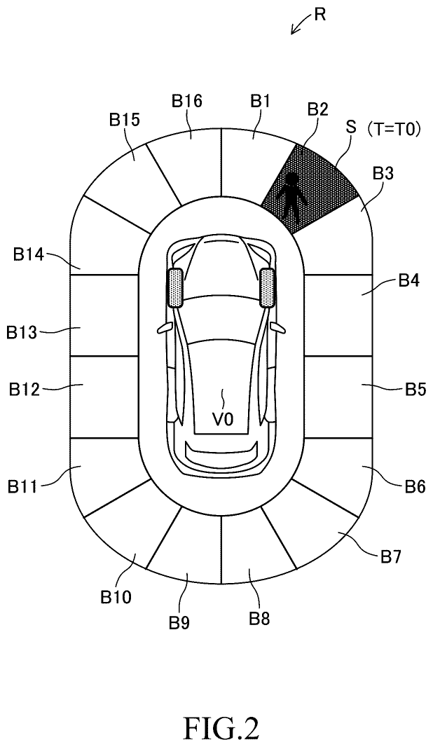

In order to call attention of the driver to a three-dimensional object OBx (x=a, b, . . . ) detected by the sonar 21, the ECU 10 controls the image display device 30 such that a predetermined shape S (object detection image) indicating the detection result is superimposed and displayed on the surrounding image G. Specifically, as shown in FIG. 2, in the surrounding image G, an area R corresponding to the object-detectable area of the sonar 21 is set. As described above, the object-detectable area has an annular (belt-like) oblong shape in a plan view. Therefore, the area R also has an annular oblong shape. The area R is equally divided, in a circumferential direction, into a plurality of sections (angular ranges). For example, as shown in FIG. 2, the area R is divided into 16 sections (sections B1 to B16). The ECU 10 controls the image display device 30 such that a shape S having the same shape and the same size as a section Bk is superimposed and displayed (such that an inside of the section Bk is filled in) on, among the sections Bk (k=1, 2, . . . , 16), a section Bk corresponding to the detection result of the sonar 21 (an area occupied by the three-dimensional object OBx) (a section Bk corresponding to a position (direction) of the three-dimensional object OBx).

Here, when a shape S is superimposed and displayed on a section Bk (k=1, 2, . . . , 16) in the surrounding image G, the shape S is displayed translucently (semi-transparently) such that a driver can visually recognize an inside portion of the section Bk (a part of a photograph acquired by the camera 22). Here, when a relatively low value is assigned to transparency T of the shape S so as to make the shape S noticeable, an effect of calling attention to the driver is enhanced, but visibility of a portion of the surrounding image G covered by the shape S (the inside portion of the section Bk) is reduced.

Therefore, the ECU 10 adjusts transparency T of the shape S according to a situation as described below (transparency adjustment processing).

Incidentally, for example, in a situation where a distance between an own vehicle and a three-dimensional object is relatively large, a situation where the distance is increasing (a situation where the three-dimensional object is moving away from the own vehicle), or a situation where a driver is highly likely to notice a three-dimensional object around the own vehicle (a three-dimensional object detected by the sonar 21), a risk of contact between the own vehicle and the three-dimensional object is relatively low. Therefore, in this case, even if transparency T of the shape S is relatively high, there is no problem. That is, in this case, even if a degree of calling attention to the driver is somewhat lowered, safety of the own vehicle and surroundings thereof is maintained at a high level. Therefore, the ECU 10 determines whether a risk of contact between the three-dimensional object detected by the sonar 21 (a three-dimensional object in the section Bk) and the own vehicle is high.

Specifically, the ECU 10 determines whether a distance ΔDk between the three-dimensional object in the section Bk and the own vehicle is equal to or less than a threshold ΔDkth. When the ECU 10 determines that the distance ΔDk between the three-dimensional object in the section Bk and the own vehicle is equal to or less than the threshold ΔDkth, the ECU 10 determines whether the distance ΔDk tends to decrease. For example, the ECU 10 acquires the distance ΔDk at a predetermined cycle, and each time the ECU 10 acquires the distance ΔDk, the ECU 10 stores, in the RAM 10c, the distance ΔDk in association with a current time. The ECU 10 refers to the time-series data, and when the distance ΔDk acquired this time is smaller than the distance ΔDk acquired last time, determines that the distance ΔDk tends to decrease.

When the ECU 10 determines that the distance ΔDk tends to decrease, the ECU 10 determines whether a situation is a situation in which a driver is highly likely to notice a three-dimensional object around the own vehicle (a situation in which a recognition level of the driver is high). In the present embodiment, when the warning sound playback function is disabled by a manual operation, the ECU 10 determines that the recognition level of the driver is high.

When the ECU 10 does not determine that the recognition level of the driver is high (when the ECU 10 does not determine that the warning sound playback function is disabled by a manual operation (situation S1)), the ECU 10 determines that a risk of contact between the own vehicle and the three-dimensional object is high, and assigns a standard value T0 to transparency T of a shape S to be superimposed and displayed on the section Bk. That is, in this case, as shown in FIG. 2, transparency T of the shape S to be superimposed and displayed on the section Bk is adjusted such that the section Bk is relatively noticeable in the surrounding image G (such that the driver can easily recognize the shape S).

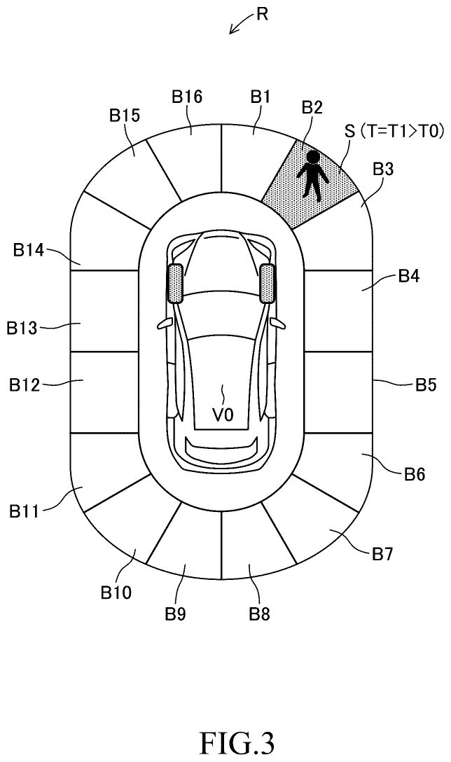

On the other hand, when the ECU 10 determines that the distance ΔDk exceeds the threshold ΔDkth (situation S2), the ECU 10 determines that a risk of contact between the own vehicle and the three-dimensional object is low. In addition, even if the distance ΔDk is equal to or less than the threshold ΔDkth, when the ECU 10 does not determine that the distance ΔDk tends to decrease (a situation where the distance ΔDk does not change, or a situation where the distance ΔDk tends to increase (situation S3)), the ECU 10 determines that the risk of contact between the own vehicle and the three-dimensional object is low. In addition, in a situation where the distance ΔDk is equal to or less than the threshold ΔDkth, when the ECU 10 determines that the distance ΔDk tends to decrease and determines that the warning sound playback function is disabled by a manual operation (situation S4), the ECU 10 determines that the risk of contact between the own vehicle and the three-dimensional object is low. In these cases, as shown in FIG. 3, the ECU 10 assigns a value T1 higher than the standard value T0 to transparency T of the shape S to be superimposed and displayed on the section Bk. That is, transparency T of the shape S is adjusted such that a driver can relatively easily visually recognize an image of the inside portion of the section Bk.

Note that, when situations for all of the sections Bk correspond to any of situations S2 to S4, the ECU 10 does not cause the buzzer 40 to reproduce a warning sound. That is, when a situation for at least one section Bk corresponds to the above-described situation S1, the ECU 10 causes the buzzer 40 to reproduce a warning sound.

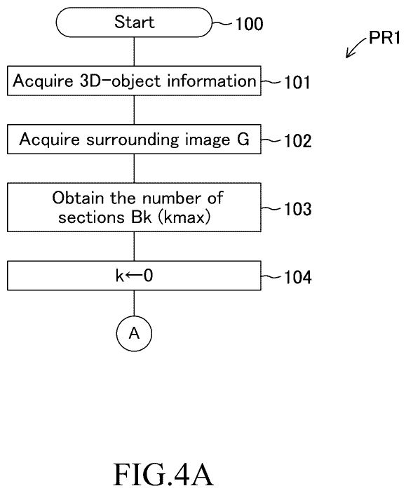

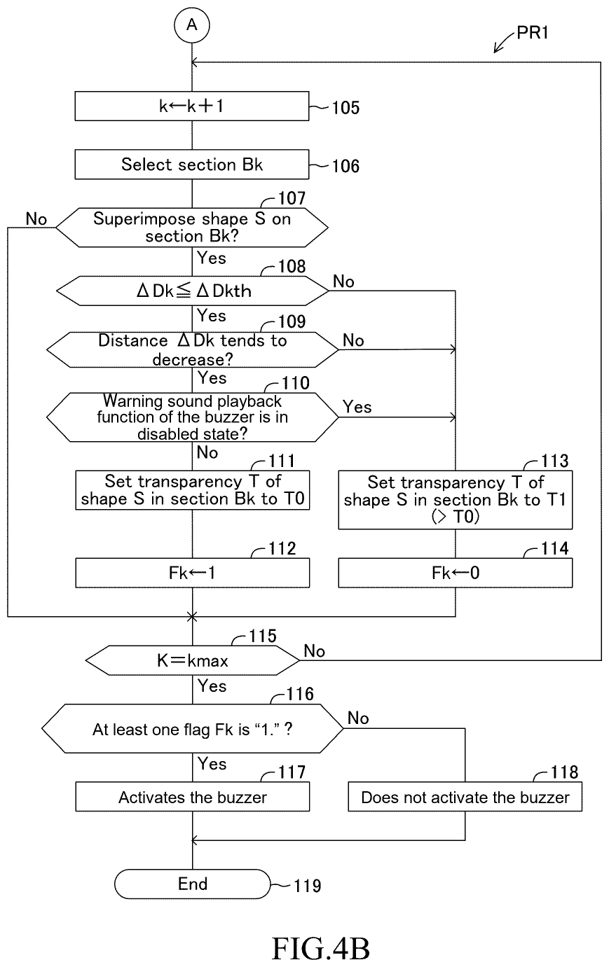

Next, with reference to FIGS. 4A and 4B, a description will be given of a program PR1 executed by a CPU 10a (hereinafter simply referred to as a “CPU”) in order to realize the above-described function of the driving assistance device 1 (a function of setting transparency T of the shape S according to a situation). The CPU executes the program PR1 in a predetermined scene. Specifically, based on information acquired from the camera 22, the CPU starts executing the program PR1 at a predetermined cycle in a state where frame lines of a parking spot are detected (a state where the own vehicle is highly likely to be parked in the parking spot). Note that, in the program PR1, a flag Fk corresponding to each section Bk is used. As will be described later, the flag Fk is used to switch an operation state (sounding/muting) of the buzzer 40.

### Program PR1

The CPU starts executing the program PR1 from step 100 and proceeds to step 101.

In step 101, the CPU acquires three-dimensional object information from the sonar 21. Next, the CPU proceeds to step 102.

In step 102, the CPU acquires, from each imaging device of the camera 22, images obtained by capturing a front area, a rear area, a left area, and a right area, synthesizes (transforms) these images, and generates (acquires) a surrounding image G. Next, the CPU proceeds to step 103.

In step 103, the CPU acquires the number kmax of sections Bk. In the example shown in FIGS. 2 and 3, the number kmax is “16.” Next, the CPU proceeds to step 104.

In step 104, the CPU initializes an index k, which is used to select (designate) a section to be processed (a section to be subjected to processing including steps 107 to 113 described below), to “0.” Next, the CPU proceeds to step 105 (FIG. 4B).

In step 105, the CPU increments the index k. Next, the CPU proceeds to step 106.

In step 106, the CPU selects the section Bk as a processing target. Next, the CPU proceeds to step 107.

In step 107, the CPU determines whether to superimpose and display the shape S on the section Bk. That is, based on the three-dimensional object information, the CPU determines whether a three-dimensional object is present in an area corresponding to the section Bk. When the CPU determines to superimpose and display the shape S on the section Bk (107: Yes), the CPU proceeds to step 108. On the other hand, when the CPU does not determine to superimpose and display the shape S on the section Bk (107: No), the CPU proceeds to step 115.

In step 108, the CPU determines whether the distance ΔDk is equal to or less than the threshold ΔDkth. When the CPU determines that the distance ΔDk is equal to or less than the threshold ΔDkth (108: Yes), the CPU proceeds to step 109. On the other hand, when the CPU does not determine that the distance ΔDk is equal to or less than the threshold ΔDkth (108: No), the CPU proceeds to step 113.

In step 109, the CPU determines whether the distance ΔDk tends to decrease. When the CPU determines that the distance ΔDk tends to decrease (109: Yes), the CPU proceeds to step 110. On the other hand, when the CPU does not determine that the distance ΔDk tends to decrease (109: No), the CPU proceeds to step 113.

In step 110, the CPU determines whether the warning sound playback function of the buzzer 40 is in a disabled state. That is, the CPU determines whether a recognition level (attention) of the driver to a three-dimensional object located around the own vehicle exceeds a threshold. When the CPU determines that the function is in the disabled state (110: Yes), the CPU proceeds to step 113. On the other hand, when the CPU does not determine that the function is in the disabled state (110: No), the CPU proceeds to step 111.

In step 111, the CPU assigns the standard value T0 to transparency T of the shape S to be superimposed and displayed on the section Bk. Next, the CPU proceeds to step 112.

In step 112, the CPU assigns “1” to the flag Fk. Next, the CPU proceeds to step 115.

In step 113, the CPU assigns a value T1 higher than the standard value T0 to transparency T of the shape S to be superimposed and displayed on the section Bk. Next, the CPU proceeds to step 114.

In step 114, the CPU assigns “0” to the flag Fk. Next, the CPU proceeds to step 115.

In step 115, the CPU determines whether the index k matches the number kmax of sections Bk. When the CPU determines that the index k matches the number kmax (115: Yes), the CPU proceeds to step 116. On the other hand, when the CPU does not determine that the index k matches the number kmax (115: No), the CPU returns to step 105.

In step 116, the CPU determines whether at least one flag Fk (at least one of flags F1 to F16) is “1.” When the CPU determines that at least one flag Fk is “1” (116: Yes), the CPU proceeds to step 117. On the other hand, when the CPU does not determine that at least one flag Fk is “1” (116: No), the CPU proceeds to step 118.

In step 117, the CPU activates the buzzer 40. That is, the CPU sets the buzzer 40 to a sounding state. Next, the CPU proceeds to step 119.

In step 118, the CPU does not activate the buzzer 40. That is, the CPU sets the buzzer 40 to a muting state. Next, the CPU proceeds to step 119.

In step 119, the CPU ends execution of the program PR1.

### Effects

When a three-dimensional object is detected by the sonar 21, a part of the surrounding image G is covered by a shape S as a detection result when the shape S is superimposed and displayed on the surrounding image G, and thus there is a possibility that a driver may have difficulty visually recognizing an image of the corresponding part (a part of the surrounding image G). Here, if transparency T of the shape S is uniformly increased in order to solve this problem, there is a possibility that the driver may have difficulty recognizing that the shape S is being displayed. Therefore, in the driving assistance device 1 according to the present embodiment, the ECU 10 adjusts transparency T of each shape S according to a situation when superimposing and displaying the shape S on the surrounding image G. Specifically, in a first situation in which a risk of contact between a three-dimensional object detected by the sonar 21 and an own vehicle is relatively high, the ECU 10 assigns a standard value T0 (a value having relatively low transparency) to transparency T of the shape S relating to the three-dimensional object. On the other hand, in a second situation in which the risk of contact is relatively low, the ECU 10 assigns a value T1 higher than the standard value T0 to transparency T of the shape S relating to the three-dimensional object. That is, the ECU 10 controls the image display device 30 such that a shape S relating to a three-dimensional object having a high risk of contact with the own vehicle is displayed in a manner more noticeable than a shape S relating to a three-dimensional object having a low risk of contact. As described above, in the present embodiment, in the first situation in which a risk of contact between an own vehicle and a three-dimensional object is high, it is allowed that visibility of the surrounding image G is slightly reduced and a degree of calling attention to the three-dimensional object is increased. On the other hand, in the second situation in which a risk of contact between an own vehicle and a three-dimensional object is low, it is allowed that a degree of calling attention is slightly reduced and visibility of the surrounding image G is increased. As described above, according to the present embodiment, it is possible to provide a driving assistance device 1 having a function of superimposing and displaying information acquired by the sonar 21 on a surrounding image G indicating surroundings of an own vehicle, the driving assistance device 1 having a function of displaying the shape S in an appropriate manner (transparency) according to a situation.

### Modification 1

The ECU 10 may, regardless of a tendency of change of the distance ΔDk and a recognition level of a driver, simply determine that a risk of contact between an own vehicle and a three-dimensional object is high when the distance ΔDk is equal to or less than the threshold ΔDkth.

### Modification 2

In the above embodiment, when the distance ΔD is equal to or less than the threshold ΔDth, the ECU 10 determines that a risk of contact between an own vehicle and a three-dimensional object is high. Instead of this, the ECU 10 may acquire a time-to-collision TTC, which is a time required until the own vehicle and the three-dimensional object come into contact, based on a change of the distance ΔD between the own vehicle and the three-dimensional object, and determine that a risk of contact between the own vehicle and the three-dimensional object is high (determine that the predetermined condition of the present invention is satisfied) when the time-to-collision TTC is equal to or less than a threshold TTCth.

### Modification 3

A vehicle interior camera as a driver sensor for detecting a recognition level of a driver (a level of attention to a three-dimensional object located around an own vehicle) may be provided. In this example, based on an image obtained by capturing a head of the driver with the vehicle interior camera, the ECU 10 acquires a line of sight of the driver. Then, when a direction of the line of sight of the driver matches a direction in which a three-dimensional object detected by the sonar 21 is located, the ECU 10 determines that the recognition level of the driver is high, and assigns a value T1 higher than the standard value T0 to transparency T of a shape S relating to the three-dimensional object. (Modification 4)

Instead of (or in addition to) the sonar 21, a LiDAR that emits laser light to a surrounding area of an own vehicle and detects a three-dimensional object located around the own vehicle based on reflected light may be used. In addition, instead of (or in addition to) the sonar 21, a millimeter-wave radar that emits millimeter-wave radio waves to a surrounding area of an own vehicle and detects a three-dimensional object located around the own vehicle based on reflected waves may be used.

### Modification 5

In the above embodiment, an object-detectable area of the sonar 21 (object detection sensor) covers an entire circumference of an own vehicle. Instead of this, the object-detectable area of the sonar 21 may be limited to a predetermined area rather than covering the entire vehicle. For example, the sonar 21 may be incapable of detecting a three-dimensional object located on a side of the own vehicle (for example, sections B5, B6, B15, and B16 in FIG. 2).

What is claimed is:

1. A driving assistance device comprising:
an in-vehicle sensor including a camera for acquiring a surrounding image which is an image of a surrounding area of an own vehicle, and an object detection sensor for acquiring information relating to a position of a three-dimensional object present in a predetermined object-detectable area within the surrounding area;
a display device for displaying an image; and
a processor configured to control the display device such that an object detection image indicating a detection result of the three-dimensional object is superimposed and displayed on, among an entire area of the surrounding image, an area corresponding to the position of the three-dimensional object detected by the object detection sensor,
wherein the processor is configured to, when the three-dimensional object is detected by the object detection sensor, determine whether a predetermined condition for determining that a risk of contact between the three-dimensional object and the own vehicle is high is satisfied, assign a standard value to a transparency of the object detection image relating to the three-dimensional object when the predetermined condition is satisfied, and assign a value higher than the standard value to a transparency of the object detection image relating to the three-dimensional object when the predetermined condition is not satisfied.

2. A driving assistance device according to claim 1,
wherein the processor is configured to determine that the predetermined condition is satisfied when a distance between the three-dimensional object and the own vehicle or a time predicted to be required until the three-dimensional object and the own vehicle come into contact is equal to or less than a threshold.

3. A driving assistance device according to claim 1,
wherein the processor is configured to determine that the predetermined condition is not satisfied when a distance between the three-dimensional object and the own vehicle is equal to or less than a threshold and when it is determined that the distance is constant or increasing.

4. A driving assistance device according to claim 1,
wherein the processor is configured to acquire a recognition level of a driver of the own vehicle and determine that the predetermined condition is not satisfied when it is determined that the recognition level exceeds a threshold.

5. A driving assistance device according to claim 4,
wherein the processor is configured to activate a buzzer mounted on the own vehicle when a distance between the three-dimensional object and the own vehicle or a time predicted to be required until the three-dimensional object and the own vehicle come into contact transitions from a state exceeding a threshold to a state equal to or less than the threshold, and determine that the recognition level exceeds the threshold when an occupant of the own vehicle is in a state in which activation of the buzzer is temporarily manually disabled.
